(19) United States
(12) Patent Application Publication
(10) Pub. No.: US 2008/0196572 A1
(43) Pub. Date: Aug. 21, 2008

(54) Navarro guitar support

(76) Inventor: Jose Angel Navarro, Miami, FL (US)

Correspondence Address: JOSE A. NAVARRO, 14462 SW 12th LN, MIAMI, FL, 33184, US

(21) Appl. No.: 11/706,163

(22) Filed: Feb. 15, 2007

(51) Int. Cl. G10G 5/00

(52) U.S. Cl. 84/327

(57) ABSTRACT

It is a support designed to hold the guitar in the proper playing position while resting on the guitarists lap. The support is manufactured from two rigid pieces, one is flat and rectangular the second is also rectangular in shape but slightly curved. The two rectangular pieces are connected to each other using a hinge. Suction cups are attached to the rectangular pieces and are used to attach the support to the lower body of the guitar. When the device is in the closed position the semi-curved edge is placed over the guitarist lap and proper playing position achieved.

### BACKGROUND OF THE INVENTION

The invention relates to guitar supports that hold the guitar in proper position for seated play according to the classical music playing position. The prior art has not addressed the problem of holding the guitar firmly while allowing the musician a full freedom of movement of the fretting hand to the guitar neck and body.

### BRIEF SUMMARY OF THE INVENTION

This invention relates to the manufacture of an ergonomic guitar support, which rests on the guitarist thigh and permits the user to move the fretting hand the complete length of the guitar. The support is manufactured from two rigid pieces that when joined form a “J”. The “J” shape permits the user to move the left hand the complete length of the guitar. The guitar support is attached to the body of the guitar via two suction cups. The suction cups, are affixed in a diagonal position, which provide a pivot point and proportionally distribute the weight evenly as the instrument is being played. The “J” shape design affords an ergonomic fit to the guitarist thigh and improves the comfort and playability of the guitar, due to the curved shape it fits securely on the musician's thigh providing a wider area of support and resistance to slippage.

Disclosed ergonomic guitar support is a utility device designed to support a guitar in the traditional way that the instrument is played. It places the instrument (Guitar) at an angle that is natural and provides comfort to the user. It is intentionally designed to blend in with the shape or the instrument and conceal its presence.

Disclosed ergonomic guitar support is currently manufactured (on its initial release) in acrylic, but it can be manufactured of just about any solid material such as metal, carbon fiber or wood.

Disclosed ergonomic guitar support consists of two acrylic pieces and a metal hinge. One piece is fiat and straight and has two holes placed at an angle that permit the attachment of suction cups which are used to attach the device to the body of the Guitar. The second acrylic piece is curved with a smaller hole centered at one end. This hole used to attach a smaller suction cup, which is used to secure the curved piece to the guitar body, when is not being used or stored. The metal hinge joins the two acrylic pieces and allows the device to be opened while being used and in the closed position when being stored.

Disclosed ergonomic guitar support is designed in such a way that permits the free movement of the left hand the full length of the body of the guitar. This is particular to its design since there are no obstructions, which would hinder the user from moving the left hand into the lower portion of the guitar. This geometric J shape of the disclosed ergonomic guitar support demonstrates a definitive difference in design from other guitar supports P2 in existence; as it creates an open area underneath the guitars body one above the musician's thigh.

The diagonal position of the suction cups evenly on the fiat piece of acrylic is designed to dissipate the stress/load on the support thereby making them more prone to sticking on the body of the guitar. This also provides flexibility and aid in the natural position in which the instrument is played, thus reducing the tendency of slippage from the thigh of the user.

Disclosed ergonomic guitar support permits by its design the use of proper posture while playing the instrument. The proper posture provides back and muscle pain relief, such as would be experienced by users of a foot stool.

Disclosed ergonomic guitar support is convenient, as it does not need to be removed when the guitar is stored in the carrying case. The fact that the device can be stored with the instrument reduces the risk of loosing it. The use of the disclosed ergonomic guitar support also eliminates the need for specific seat height when playing the guitar.

This design also permits better resonation of the guitar's body due to the reduced amount of surface area that comes in contact with the body of the guitar. In the traditional position the guitar rest on the musician's thigh thereby causing a muffling effect on the guitar's body. The disclosed ergonomic guitar support attaches to the guitar body vial the two suction cups letting the body vibrate freely.

### BRIEF DESCRIPTION OF THE SEVERAL VIEWS OF THE DRAWING

FIG. 1A view of the assembled support in the closed position.

FIG. 2 Illustration of the Support attached to the guitar in the Classical playing position.

FIG. 3 A view of the assembled support in the open position.

FIG. 4 Illustration of the support, viewed from above as it lays flat, with exploded view of diagonal auction cup holes.

FIG. 5 Illustration of a guitar body With the support attached in the open position ready for storage.

FIG. 6 Illustration of a guitar body with the support in the closed position ready for playing.

FIG. 7 Drawing depicting the support attached to the guitar in the closed position.

FIG. 8 Lateral view of the support in closed position.

FIG. 9 Semi-curved plate.

FIG. 10 Flat rectangular mounting plate.

FIG. 11 Metal Hinge used to join the semi-curved plate to the rectangular plate.

FIG. 12 Interconnecting screws male FIG. 13 Standard large size suction cup.

FIG. 14 Standard small size suction cup.

FIG. 15 Round Plastic Bumper.

FIG. 16 Lateral view of assembled guitar support.

### DETAILED DESCRIPTION OF THE INVENTION

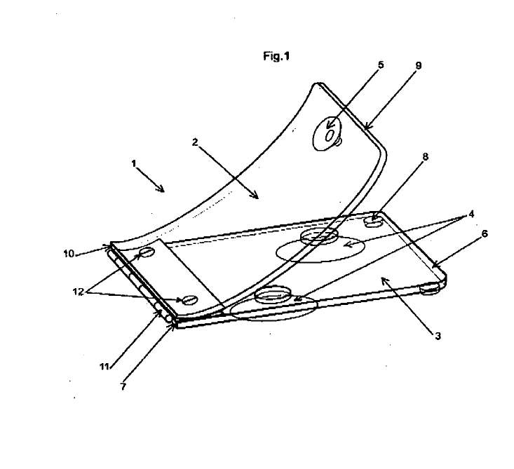

FIG. 1 shows a perspective view of the guitar support 1.

The guitar support is formed of the semi-curved plate 2, and flat plate 3, joined by a hinge 11. The flat plate 3 has suction cups 4, placed diagonally from each other, as shown. The flat plate 3 has a first end 6 and a second end 7, where the second end is attached to hinge 11. The suction cups 4 attach to the lower waist area 14 of a guitar 13 when in use as shown in FIG. 2.

FIG. 1 shows a first end 9 of the semi-curved plate 2 that has a suction cup 5 and a second end 10 of the semi-curved plate 2 attaches to hinge 11 by screws 12. By the hinge 11, semi-curved plate 2 is pivoted to a stored position 22 as shown in FIG. 5

Also, by the hinge 11, semi-curved plate 2 is pivoted to a ready to play position 23 as shown in FIG. 6.

FIG. 2 shows the support 1 attached to a guitar 13 near the waist 14 of said guitar 13 by the two suction cups 14 in the proper classical playing position. The full range of movement of the fretting hand 15 is additionally indicated.

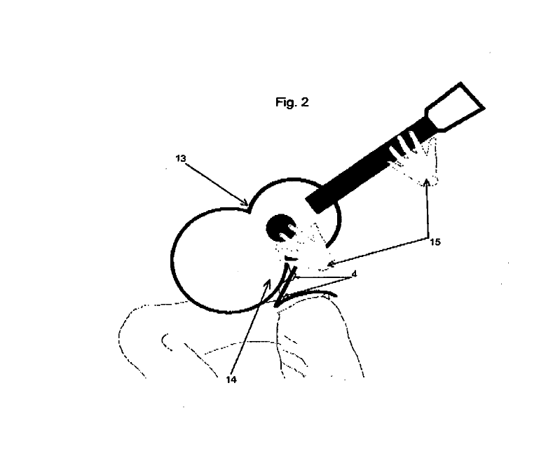

FIG. 3 depicts the support in the open position 16 and a view of the hinge 11 secured by the screws 12 and nuts 17.

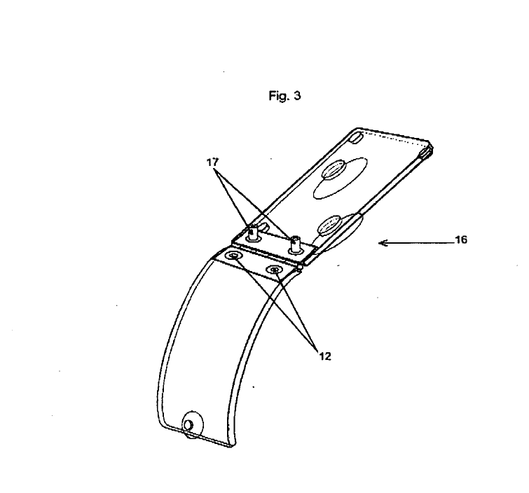

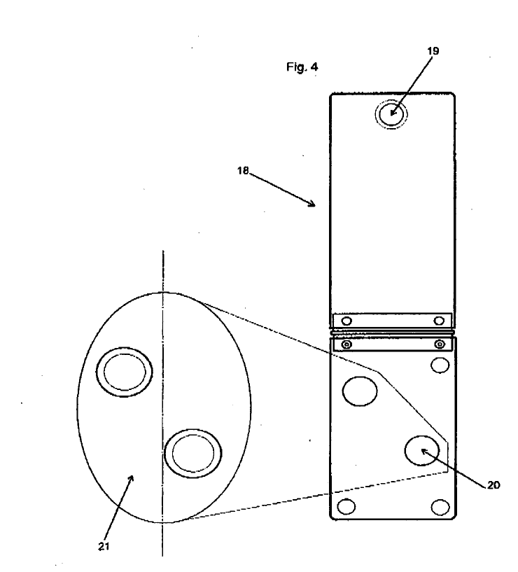

FIG. 4 shows the support 1 in a flat perspective is, which indicates the hole 19 for the small suction cup 5 and the hole 20 for the larger suction cups 4. Also included is an exploded view 21 of the large suction cup 4 and hole 20.

FIG. 5 illustrates a guitar with the support in the open position 22.

FIG. 6 illustrates a guitar with the support in the closed position 23.

FIG. 7 illustrates a horizontal view of the support in the open position with the suction cups facing up 24;

FIG. 8 illustrates a horizontal view of the support in the closed position with the suction cups facing up 25;

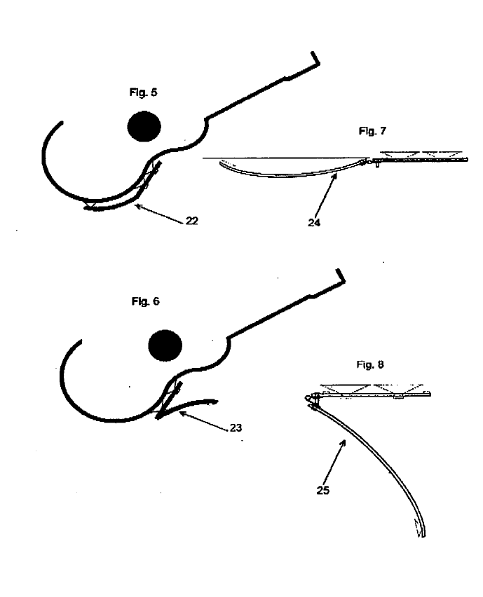

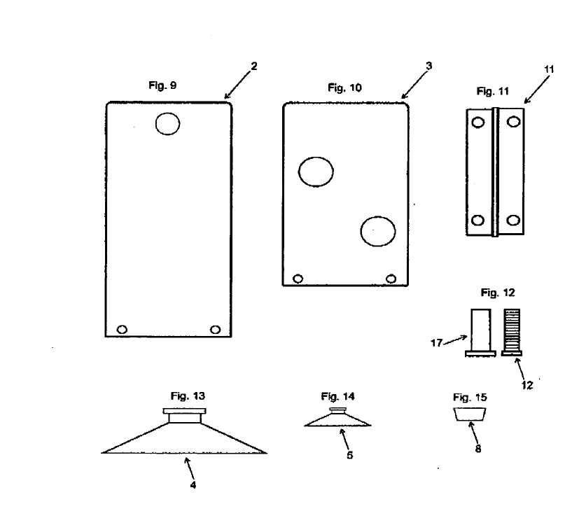

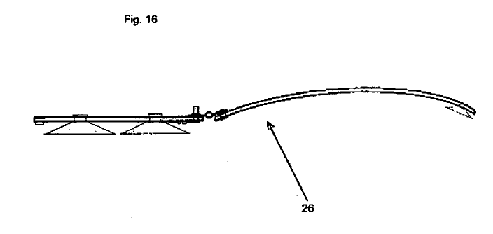

FIG. 9 shows the semi-curved piece 2 unassembled in flat perspective; FIG. 10 shows the flat piece 3 unassembled in a flat perspective; FIG. 11 is the metal hinge 11 in a flat perspective; FIG. 12 shows a profile view of screw 12 and nut 17; FIG. 13 illustrates a profile view of large suction cup 4; FIG. 14 illustrates a profile view of small suction cup 5: FIG. 15 illustrates a profile view of bumper 8; FIG. 16 illustrates a horizontal view of support in the open position with the suction cups facing down 26.

1. (canceled)

2. (canceled)

3. (canceled)

4. (canceled)

5. (canceled)

6. A guitar support comprising:
a first rigid plate, rectangular in shape and flat in nature, comprising a face that has two suction cups placed in a diagonal position to each other that are used to attach the device to the lower section of a guitar in the vicinity of the guitar's waist;
the first plate further comprising a first and second plate end, wherein the second end has an interface for connecting a hinge;
a second rigid plate, rectangular in shape and semi-curved in nature, comprising a concave and a convex face and a first and a second end, the first end having a suction cup on the concave face;
and an interface for a hinge on the second end;
the shape of the semi-curved plate provides an area of support following the contour of a musician's leg that prevents the support from sliding due to the small suction cup;
a hinge secured to the second ends of each rectangle to connect the second end of the flat plate to the second end of the curved plate, wherein in a closed position of the hinge, the suction cups on the flat and curved plate face outward from each other;
the small suction cup is also used to secure the semi-curved plate to the guitar's body when the hinge is opened and this prevents damage to the guitar's body by preventing the support from touching the body of the guitar;
wherein the support is placed on the guitar in a position that permits the user to attain both the proper classical guitar playing position and the free and complete movement of the fretting hand over the entire length of the guitar's neck and body.
